(19) United States
(12) Patent Application Publication
(10) Pub. No.: US 2010/0134414 A1
(43) Pub. Date: Jun. 3, 2010

(54) INPUT APPARATUS WITH BALL

(75) Inventor: John Cavacuiti, North Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO BRANDS USA LLC

(21) Appl. No.: 12/595,540

(22) PCT Filed: Apr. 11, 2008
(86) PCT No.: PCT/US08/04789

§ 371 Date: Oct. 12, 2009

Related U.S. Application Data
(60) Provisional application No. 60/911,786, filed on Apr. 13, 2007.
(60) Provisional application No. 60/914,089, filed on Apr. 26, 2007.

(51) Int. Cl. G06F 3/02; G09G 5/00; G06F 3/033

(52) U.S. Cl. 345/158; 345/156; 345/168

(57) ABSTRACT

An input apparatus is disclosed. The input apparatus provides a control signal to a host system. It includes a housing that includes an upper portion and a lower portion. A ball is coupled to the upper portion of the housing and can reside within a ring. A first sensor assembly is configured to sense the position of the ball, and a second sensor assembly is configured to sense the position of the input apparatus relative to a work surface. The input apparatus also includes a mode switch, where the mode switch is operatively coupled to the first sensor assembly and the second sensor assembly. The mode switch includes a first mode where the first sensor assembly provides the control signal to the host system and a second mode where the second sensor assembly provides the control signal to the host system.

### CROSS-REFERENCES TO RELATED APPLICATIONS

This patent application is a non-provisional of and claims the benefit of the filing date of U.S. provisional patent application Nos. 60/911,786 filed on Apr. 13, 2007 and 60/914,089 filed on Apr. 26, 2007, all of which are herein incorporated by reference in their entirety for all purposes.

### BACKGROUND

A number of computer input apparatuses are known. Examples of computer input apparatuses include trackballs, mice, remote controls, etc.

Although some input apparatuses are useful in some situations, they may not be useful in certain situations. For example, a user may prefer to use a mouse instead of a trackball. If, however, the user is in a confined working environment such as a plane or train and can only use a work surface with a limited space, the use of the mouse may not be practical. In this case, the user may prefer using a trackball instead of a mouse.

In another example, some households may have many different users that may use the same host computer system. One user may prefer using a mouse, while another user may prefer using a trackball. In this case, both a mouse and a trackball are used with that host computer system. Using both a mouse and a trackball with the same computer system can be cumbersome and expensive.

Yet another problem is that some work surfaces may not be suitable for use with an optical mouse. A typical optical mouse uses a sensor which captures images of the work surface upon which it is used, and compares the captured images to determine the movement of the mouse relative to the work surface. If the work surface is too optically uniform, the optical mouse may not work very well. The user may not be able to use the optical mouse if the particular work surface that is available is not suitable for use with an optical mouse. In this case, the user may prefer using a trackball instead of an optical mouse.

Embodiments of the invention address these and other problems, individually and collectively.

### BRIEF SUMMARY

Embodiments of the invention are directed to improved input apparatuses for use with host systems such as host computer systems.

One embodiment of the invention is directed to an input apparatus. The input apparatus provides a control signal to a host system. It includes a housing that includes an upper housing portion and a lower housing portion, and a ball at the upper portion of the housing. It also includes a first sensor assembly configured to sense the position of the ball, and a second sensor assembly configured to sense the position of the input apparatus relative to a work surface. It further includes a mode switch, where the mode switch is operatively coupled to the first sensor assembly and the second sensor assembly. The mode switch includes a first mode where the first sensor assembly is used to provide the signal to the host system and a second mode where the second sensor assembly is used to provide the signal to the host system. The first mode may be associated with a trackball mode whereas the second mode may be associated with a mouse mode.

Another embodiment of the invention is directed to a method for using the above-described input apparatus. The method includes selecting the first mode using the mode switch, and then using the ball to send a first control signal to the host system. The first control signal may be used to control a cursor on a display in the host system. If the user wants to use the input apparatus in a mouse mode, the user selects a second mode using the mode switch. The input apparatus then sends a second control signal to the host system. The second control signal may be used to control a cursor on a display in the host system.

Another embodiment of the invention is directed to a modular desktop assembly. It includes a keyboard comprising a first connector, and a control device comprising a second connector, where the first connector is connectable to the second connector.

Another embodiment of the invention is directed to a ball assembly for providing a control signal. It includes a housing, a holding structure, a ball cooperatively configured with the holding structure, wherein the ball is accessible from outside the housing, and a sensor assembly configured to sense the relative movement of the ball.

These and other embodiments of the invention are described in further detail below.

### BRIEF DESCRIPTION OF THE DRAWINGS

FIG. 1 shows a perspective view of an input apparatus according to an embodiment of the invention.

FIGS. 2-4 respectively show top plan, side, and bottom views of the input apparatus shown in FIG. 1.

FIG. 5 shows an exploded view of an input apparatus.

FIG. 6 shows an assembled view of a portion of an input apparatus according to an embodiment of the invention.

FIG. 7 shows an exploded view of some components of an exemplary sensor assembly.

FIG. 8 shows a block diagram of some functional components in the input apparatus.

FIG. 9 shows a block diagram of some functional components in a host system, which can be used with an input apparatus.

FIG. 10 shows a perspective view of a modular input system according to an embodiment of the invention.

FIGS. 11(a)-(d) show top, partial, and side views of a ball assembly according to embodiments of the invention.

In the Figures, like numerals designate like elements and the descriptions of like elements may not be repeated.

### DETAILED DESCRIPTION

An input apparatus is disclosed. The input apparatus is configured to provide a control signal to a host system. It includes a housing, which includes an upper portion and a lower portion. A ball is coupled to the upper portion of the housing. The input apparatus also includes a first sensor assembly configured to sense the position of the ball, and a second sensor assembly configured to sense the position of the input apparatus relative to a work surface.

A mode switch is also included in the input apparatus. The mode switch is operatively coupled to the first sensor assembly and the second optical sensor assembly. The mode switch includes a first mode where the first sensor assembly is used to provide the control signal to the host system. The mode switch may also include a second mode where the second sensor assembly is used to provide the control signal to the host system.

The above-described ball can have two modes of operation. It may have a first operational mode when the mode switch is in the first mode. In this operational mode, the ball may control a cursor on a screen of a host system. It may also have a second operational mode when the mode switch is in the second mode. In this operational mode, the ball may allow for 4-way 360 degree scrolling (i.e., scrolling in the vertical as well as the horizontal directions). In the second operational mode, rolling the ball during scrolling may cause an audio output device in the input apparatus or corresponding host system to produce clicking sounds.

Embodiments of the invention have a number of advantages. As noted above and as will be illustrated in further detail below, an input apparatus according to an embodiment of the invention can operate as a trackball or as a traditional optical or laser mouse, depending upon the preference of the user. This allows a user to use the input apparatus as a mouse if there is an appropriate work surface or as a trackball if an appropriate work surface is not available. As explained above, an appropriate work surface may not be available if the work surface is too small or if the work surface does not have suitable optical properties. In addition, if one member of a household likes to use a mouse and another member of the household likes to use a trackball, both members of the household may share one input apparatus instead of many different input apparatuses.

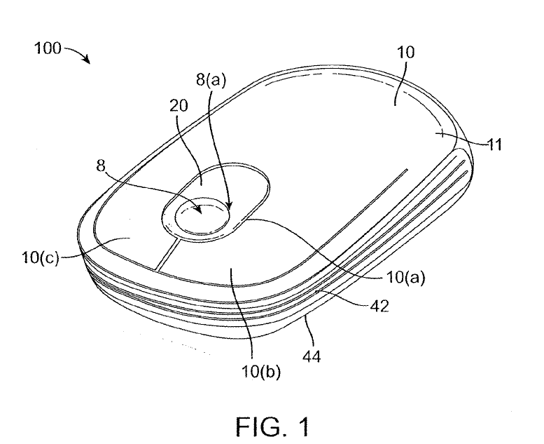

FIG. 1 shows a perspective view of an input apparatus 100 according to an embodiment of the invention. The input apparatus 100 comprises a housing 11. The housing 11 may be formed from one or more housing components including an upper housing portion 10 and a lower housing portion 44. Although the housing 11 is shown as being formed from separate housing portions 10, 44 it may be formed from more or less housing portions in other embodiments of the invention. Also, as shown in FIG. 1, an optional rubber side grip 42 is also shown around the side of the upper housing portion 10, and allows a user to comfortably grip the input apparatus 100.

The upper housing portion 10 may include an aperture 10(a), a left button 10(b) and a right button 10(c). The left and right buttons 10(b), 10(c) may be similar to those used in a traditional mouse.

A bezel 20 is present in an aperture 10(a) in the upper housing portion 10. A ball 8 is disposed in the aperture 8(a) in the bezel 20. The ball 8 may or may not be mechanically coupled to the upper housing portion 10. Further details regarding the bezel 20 and ball 8 are provided below.

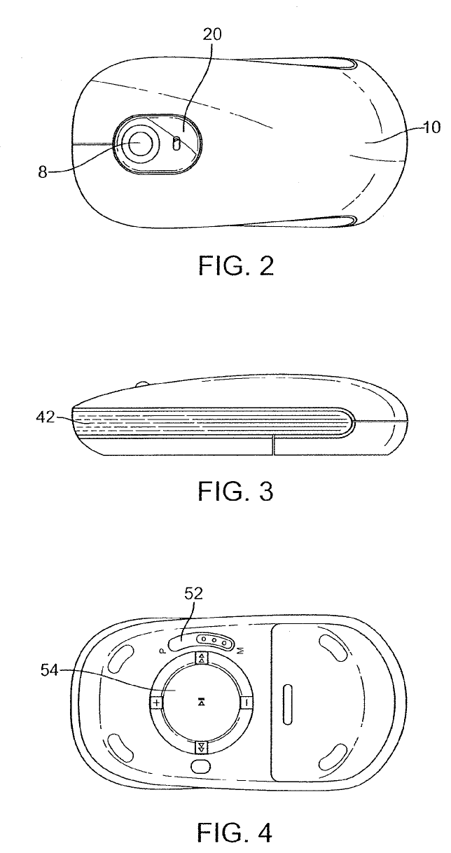

FIGS. 2-4 respectively show top plan, side (the other side of the apparatus 100 being a mirror image of the view in FIG. 3), and bottom views of the input apparatus 100.

In some embodiments, the input apparatus 100 may optionally be configured to be used as a presentation control device, and may have a presentation mode control switch and presentation controls. As shown in FIG. 4, the input apparatus 100 may comprise presentation controls including a directional pad 54 and a mode switch 52 to allow the input apparatus 100 to be used presentation controller mode, or a pointer mode (e.g., a mouse mode or a trackball mode).

Embodiments of the invention are not limited to the specific examples shown in FIGS. 1-4. For example, instead of a directional pad 54, the input apparatus 100 could alternatively use buttons which will allow a user to move forward or backward through a presentation such as Microsoft Powerpoint™. In some embodiments, the input apparatus 100 may also comprise a laser pointer (not show). Also, instead of providing for a separate presentation/pointer mode switch 52, in other embodiments of the invention, the presentation mode could be selected by the user using the previously described bezel 20 (see FIG. 1). For example, a user may press down on the bezel 20 once to put the input apparatus 100 in a mouse mode, twice to put the input apparatus 100 into a trackball mode, and three times to put the input apparatus 100 into a presentation mode. Computer code for allowing the input apparatus 100 to switch between these different modes can be present in a memory in the input apparatus 100. Output indicators (not shown) such as LEDs or the like may be used to indicate which mode the input apparatus 100 is currently in.

In yet other embodiments, instead of providing for a separate set of presentation controls on the bottom of the input apparatus 100, the previously described buttons 10(b), 10(c) can be used as presentation control elements to move a presentation forward or backward. This is described in U.S. Provisional Patent Application No. 60/911,803, filed Apr. 13, 2007 (attorney docket no. 14572P-083300US), and which is herein incorporated by reference in its entirety. Any feature described therein may be combined with any feature in any embodiment in this application.

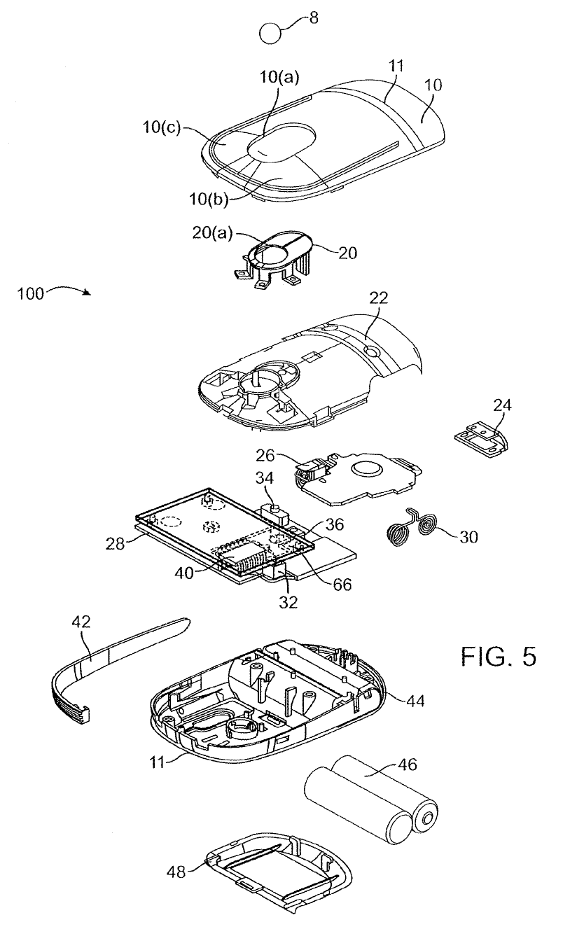

FIG. 5 shows an exploded view of the input apparatus 100. (In this embodiment, there arc no presentation controls on the input apparatus 100.) The input apparatus 100 comprises a housing 11 comprising an upper housing portion 10, a lower housing portion 44, and a battery cover 48. A side grip 42 is attached to the housing 11. The upper housing portion 10 comprises left and right buttons 10(b), 10(c), as well as a central aperture 10(a). A bezel 20 comprising another aperture 20(a) is present in the central aperture 10(a) in the upper housing portion 10. A ball 8 is disposed in the aperture 20(a) in the bezel 20. Ball 8 may optionally be disposed within a holding structure (not shown) located within the aperture 20(a). Examples of holding structures are provided below.

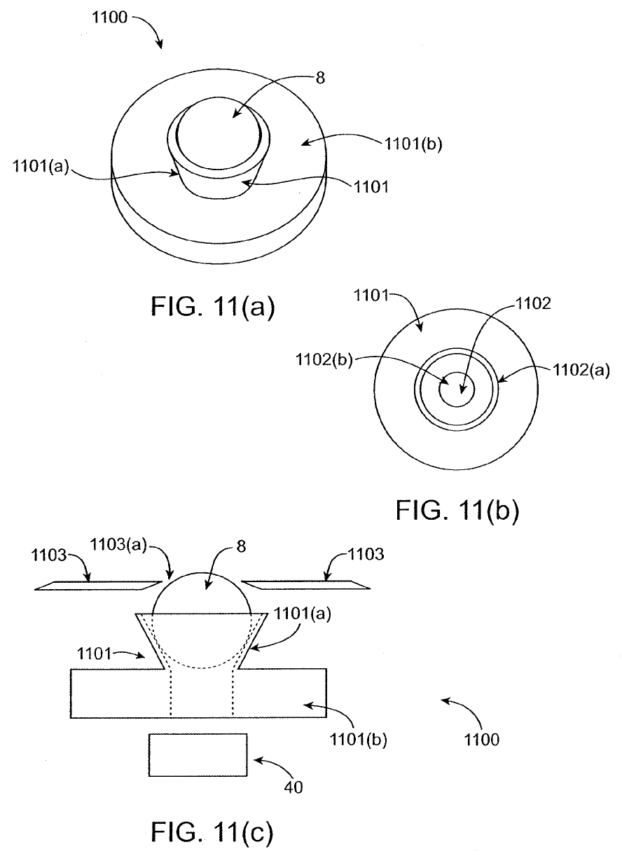

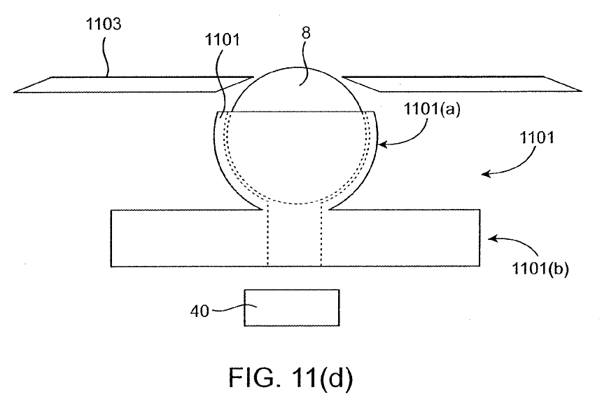

The ball 8 may have any suitable configuration or properties. For example the ball 8 is preferably less than about 20, 10, 8, or even 5 mm in diameter. It can have speckles (e.g., metal particles) in it to allow for easier tracking. In some embodiments, the size of the ball 8 is smaller than a normal trackball and can be manipulated by a user using a single finger. In some embodiments, ball 8 has a diameter between approximately 7 mm to approximately 15 mm. Additional descriptions of a ball and a related ball assembly are described below with reference to FIGS. 11(a)-11(d).

The ball that is described herein may not only be used in an input apparatus such as a mouse, but it may also be used in other types of apparatuses including a mobile phone, a gaming device, an MP3 player, a PDA, a laptop computer, etc. The ball may be small and the movement may be tracked with an optical assembly.

The battery cover 48 provides access to batteries 46 (e.g., two AA batteries) within the housing 11. A battery terminal 30 and a battery gauge 24 for indicating the mode of the batteries 46 are also within the housing.

In some embodiments, the battery gauge 24 may have a series of four LEDs (one battery icon LED and three square LEDs) that has the following indication for battery voltages. The four battery LEDs may light up for 5 seconds at start up or when the input apparatus is re-connected to the host system. If the batteries have sufficient power, all LEDs may light up green with the number of squares lighting up based on the power left in the batteries. If the batteries 46 in the input apparatus 100 need to be replaced (voltage between 1.8 V and 2.0 V), the battery icon may flash once every two seconds for sixty seconds and the other squares will not illuminate. To indicate to the user how much power is left, the three square LEDs may light up if the battery voltage is above 2.6V (battery level>75%), two square LEDs may light up if he battery voltage is between 2.2V and 2.6 V (75% >battery level>50%), and one square LED may light up if the battery voltage is between 2.0 V and 2.2 V (50% >battery leve l>25%). For a battery voltage below 1.8 V, the input apparatus 100 may shut down.

Inside of the housing 11 is a printed circuit board 28 upon which a first optical sensory assembly 40 and a second optical sensor assembly 66 are mounted. The first and second optical assemblies 40, 66 preferably comprise a laser as a light source. In other embodiments, the light source may be an LED or other illumination device. In this example, a light source and optical sensor in the first optical assembly 40 face up and track the movement of the ball 8, while the light source and optical sensor in the second optical assembly 66 face down and track the movement of the input apparatus 100 relative to the work surface (not shown) upon which it is disposed.

Although optical sensor assemblies are described in detail, other types of sensor assemblies could be used. However, optical assemblies are preferred as they include few moving parts and are generally more reliable than purely mechanical systems. Further details regarding components that can be present in the first and second optical assemblies 40, 66, are provided below.

As noted above, the first optical sensor assembly 40 senses the relative movement of the ball 8 when the user moves the ball 8 as in a conventional trackball. That is, light can be provided by a light source in the first optical sensor assembly 40 to the ball 8 and the reflected image of the ball 8 may be received by a sensor chip in the first optical sensor assembly 40. Speckles or other material can be provided in the ball 8 to make its movement easier to track. The first optical sensor assembly 40 may be an optical assembly such as an ADNB-6532 sensor assembly which is commercially available from Avago Technologies, or may be other optical assemblies such as the PLN2021 laser sensor, which is commercially available from Royal Philips Electronics.

The second optical sensor assembly 66 senses the relative movement of the input apparatus 100 relative to a work surface as in a conventional mouse. That is, light can be provided by a light source in the second optical sensor assembly 66 to an underlying work surface (e.g., a desk surface), and light can be reflected from the work surface indicating the relative movement of the input apparatus 100 relative to the work surface. The second optical sensor assembly 66 may be an ADNS-7050 sensor, which is also commercially available from Avago Technologies.

A printed circuit board and piezoassembly 26, and an RF module 36 may also be present in the housing and may be coupled to the printed circuit board 28. The RF module 36 may comprise an antenna (not shown) which allows the input apparatus 100 to communicate with a host system (not shown). RF specifications for the input apparatus 100 may be as follows: Bluetooth wireless technology; operating frequencies 2.4˜2.4835 GHz; channels—79; and bandwidth—1 MHz.

A mode switch 36 is also in the housing and can be operatively coupled to the bezel 20. It is noted that a “mode switch” may be embodied by the mode switch 36 alone or in combination with the bezel 20. In this example, depression of the bezel 20 (or other type of button) activates the mode switch 36 to change the input apparatus from a mouse mode to a trackball mode. A light pipe 34 or other illumination device may be operatively coupled to the mode switch 36 and may indicate which mode the input apparatus 100 is in.

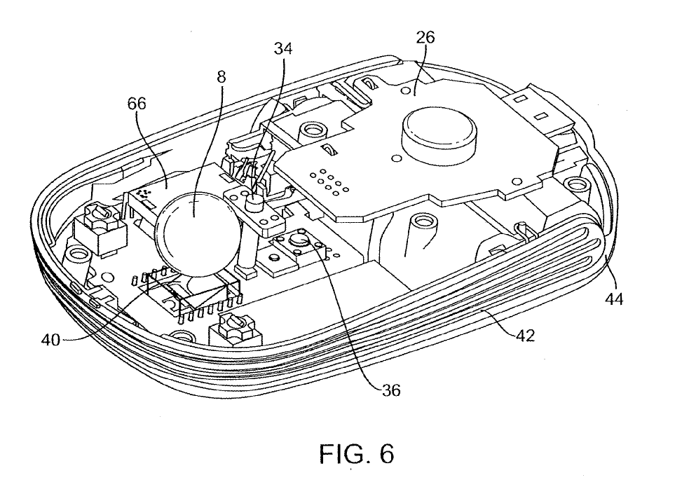

FIG. 6 shows a portion of the previously described input apparatus. In FIG. 6, the relative positions of the ball 8, the first optical sensor assembly 40 and the second optical sensor assembly 66 are shown. Other components of the input apparatus are also shown in an assembled mode.

The ball 8 may be held in place by the bezel 20 above it and an object below it, such as sensor 40. However, in other embodiments, the ball 8 may be held in place by a holding structure (not shown in FIGS. 5-6). FIGS. 11(a)-11(d) show an embodiment of the invention where a ball assembly 1100 is formed from a ball held in place by a holding structure 1101. The ball assembly 1100 can be used as part of a trackball device in an input apparatus (like the embodiments described previously) or any suitable device that uses a control system, such as a mobile phone, a gaming device, an MP3 player, a PDA, a laptop computer, etc. FIG. 11(a) shows a top perspective view of an exemplary ball assembly 1100. The ball 8 is mounted within the holding structure 1101.

The holding structure 1101 can have at least a portion that is ring shaped. In these embodiments, holding structure 1101 comprises a monolithic structure comprising a lower portion 1101(b) and a top holder portion 1101(a). The top holder portion may be configured as a single piece, continuous band that can be cooperatively configured to receive the ball 8. The top holder portion 1101(a) of the holding structure 1101 can substantially surround at least a portion of the ball 8, and can cover at least the sides and the bottom of the ball 8. There can be openings in holding structure 1101, such as in the top and bottom, for access to the ball 8 by both a user's finger(s) and an operatively coupled sensor assembly. This allows the ball 8 to be securely held within the ball assembly 1100 while allowing for smooth and easy control of the ball 8 by the user. In some embodiments, the top holder portion 1101(a) of the holding structure 1101 can be discontinuous. In one example, the top holder portion 1101(a) of the holding structure 1101 can be in the form of a plurality of separate prongs that are attached to the bottom portion 1101(b) and that hold the ball 8. In another example, the top holder portion 1101(a) of the holding structure 1101 can be an object that is substantially continuous but with portions of the sides cut out. Holding structure 1101 can comprise any suitable structure that holds the ball 8.

The holding structure 1101 can comprise a low-friction material, and can be made by molding, stamping, or other suitable process. For example, the holding structure 1101 can comprise Teflon™, Delrin™, other fluoropolymers, or some other suitable material. A fluoropolymer can be coated on a base plastic material in some embodiments. The use of a low-friction material allows the ball 8 to easily rotate while mounted within the holding structure. The ball 8 can be made of any suitable material, including but not limited to stainless steel, aluminum, ceramic, glass, resin, acrylic, etc.

FIG. 11(b) shows the holding structure 1101 without a ball mounted within it. The holding structure 1101 can have a cavity 1102 disposed within it. The cavity 1102 can be defined by surfaces which are configured to receive ball 8 (not shown), such that ball 8 is supported by holding structure 1101. In some implementations, the cavity 1102 can have an inner diameter of inwardly sloping walls in the top holder portion 1101(a). They slope from a maximum width at the top part of cavity 1102(a) to a minimum width at lower part of cavity 1102(b). The lower part of the cavity 1102(b) may be in the bottom portion 1101(b). In certain embodiments, the walls of cavity 1102 are curved, to conform to the shape of the outer surfaces of the ball 8. This configuration causes the ball 8 to be securely disposed within the cavity 1102, while still being accessible from above to a user. The width of the inside walls of cavity 1102 (i.e. the inside diameter of holding structure 1101) may vary as shown in FIG. 11(b), or the inside diameter may be constant. In certain embodiments, the inside diameter of holding structure 1101 at all locations may be less than the diameter of ball 8. Ball 8 may be only partially disposed within the holding structure 1101, with the main portion of the ball 8 projecting above the holding structure 1101. For example, the ball can be disposed within holding structure 1101 up to approximately 30° below the equator of ball 8. This allows for a majority of ball 8 to be exposed to a user, which provides for easier control and usability. In other embodiments, ball 8 is disposed within holding structure such that 1102(b) is located above the equator. This allows for the holding structure 1101 to fully hold the ball 8 such that it will remain in the correct position for use as an input device in an apparatus.

Lower part 1102(b) may be open such that cavity 1102 is a pass through cavity in holding structure 1101 as shown in FIG. 11(b). In other examples, cavity 1102 may be open at 1102(a), but closed at 1102(b). If the lower portion 1102(b) is open, a sensor assembly (not shown) can be mounted to the bottom side of holding structure 1101 such that the sensor assembly senses the position of ball 8 through the opening. In these embodiments, ball 8 is located on one side of holding structure 1101, and sensor assembly is located on another side opposite ball 8. This can allow for an optical sensor assembly to accurately track the movement and rotation of ball 8. If the lower portion 1102(b) is closed, the sensor assembly can be mounted within holding structure 1101. In other embodiments, the sensor can be elsewhere in relation to holding structure 1101, so long as the sensor is able to sense the relative movement of ball 8, as described above.

FIG. 11(c) shows a side view of an embodiment of the ball assembly 1100 as it is within a housing 1103 of an apparatus. From the side, the holding structure 1101 can be seen to include two functional parts, a top holder portion 1101(a) to hold ball 8, and a bottom portion 1101(b). Bottom portion 1101(b) can have flat sides and extend out past top holder 1101(a), in order to connect to a housing 1103 or structures below. Holding structure 1101 can comprise two separate parts 1101(a), 1101(b), that were formed separately and attached together, for example using a glue. In preferred embodiments, holding structure 1101 can be a one piece design and portions 1101(a) and 1101(b) merely refer to different areas of the single monolithic unit. In certain embodiments, the holding structure 1101 does not comprise two separate portions 1101(a), 1101(b), but rather will appear to be a single structure, such as a ring shaped structure with no extending portions.

In the embodiment of FIG. 11(c), the ball 8 is sandwiched between holding structure 1101 and the inside of the input apparatus housing 1103. The holding structure 1101 and the housing 1103 work cooperatively to keep the ball 8 in the proper position. In certain implementations, top holder 1101(a) reaches to approximately 30 degrees below the equator of ball 8.

The input apparatus housing 1103 can correspond to housing portion 10 or bezel 20 from FIG. 5. In exemplary embodiments, housing 1103 can be a housing for an apparatus such as a mobile phone, a gaming device, an MP3 player, a PDA, a laptop computer, etc. Housing 1103 can have an opening 1103(a) through which ball 8 is accessible to a user from outside the housing. The ball 8 is disposed within portion 1101(a), which is located on one side of holding structure 1101. Sensor assembly 40 can be mounted on a second side of holding structure 1101, and can be configured to sense the position of the ball. This can maintain the relative position of sensor 40 and ball 8 as shown in FIG. 6.

FIG. 11(d) shows a side view of an embodiment of ball assembly 1100 as it is within a housing 1103 of an apparatus. In the embodiment of FIG. 11(d), ball 8 is held by holding structure 1101 without the cooperation of housing 1103. As can be seen in the figure, top holder 1101(a) reaches above the equator of ball 8, and the inside of holding structure 1101 is cooperatively configured with the surfaces of the ball 8. As such, the ball 8 is maintained in the proper position by holding structure 1101 while still being fully rotatable. Ball 8 is accessible from the outside of the input apparatus housing 1103. In certain implementations, the inside walls of holding structure 1101 have a curvature that conforms to the surface of ball 8, to provide for smoother rolling.

In the embodiments of FIGS. 11(c)-11(d), an opening 1105 runs through holding structure 1101, as shown by dashed lines. Sensor assembly 40 can couple with the holding structure 1101, and sense the relative movement of ball 8 through opening 1105 as described above. In certain examples, a biasing member (not shown), such as a spring, can be used to push the ball 8 towards the housing 1103. In these examples, the biasing member can ensure that the ball 8 is accessible from outside the housing, even in situations where the ball 8 does not precisely fit within holding structure 1101.

The use of a holding structure in embodiments of the invention provide for several benefits. Embodiments of the holding structure are directed to a one-piece, ring shaped structure made of a low friction material. Such one piece structure substantially surrounds the ball to maintain it in the proper position. The ball assembly as described provides for a smoother rolling experience for the user. The ball is more easily maintained in a proper position for use within a device. Furthermore, the use of a single structure to engage with the ball is a novel yet economical way to create control devices for use in variety of modern electronics. The ball assembly as described reduces the amount of parts required to create a ball-based input device, as what is required is simply a ball, an optical sensor, and a holding structure to couple the two.

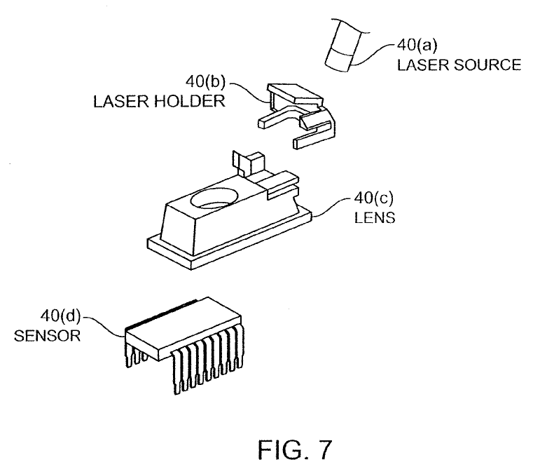

FIG. 7 shows some components that may be in the first and second optical sensor assemblies 40, 66. They include a laser source 40(a), a laser holder 40(b), a lens 40(c), and a sensor 40(d). These components may be physically coupled together. As noted above, the first and second assemblies 40, 66 may be commercially obtained.

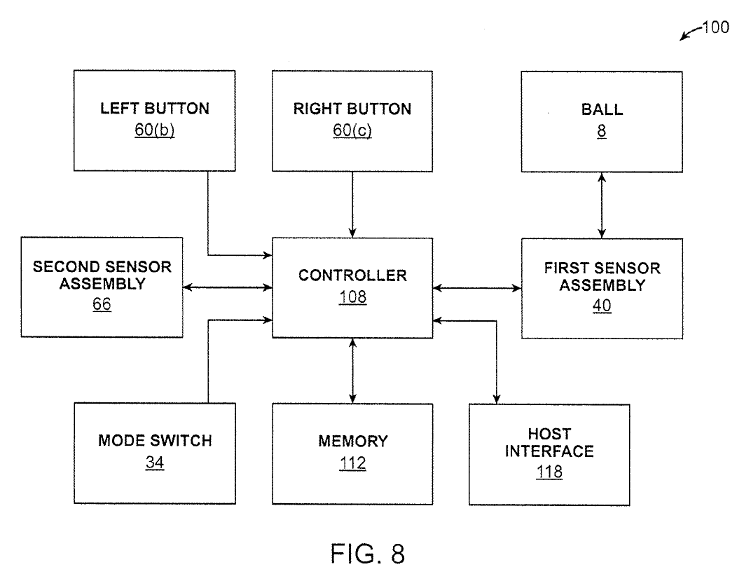

FIG. 8 shows a block diagram of some components in the input apparatus 100.

The input apparatus 100 may include a controller 108, which receives user input from right and left buttons 60(b), 60(c).

The controller 108 may also communicate with the first and second optical sensor assemblies 40, 66. As noted above, the first optical sensor assembly 40 may interact with the ball 8 to determine the extent of a user's input when the user moves the ball 8. The second sensor assembly 66 can determine the extent of the user's input when the user moves the input apparatus 100 over a work surface.

The controller 108 may also be electrically coupled to the mode switch 34 as well as a memory 112, and a host interface 118.

The controller 108 may comprise processor and may be configured to control the operation of the input apparatus 100 by executing code in the memory 112. The controller 108 may be embodied by any suitable combination of hardware and software.

The mode switch 34 may be in any suitable form. It may be include a depressible button, a slide switch, etc. As noted above, it may be embodied to one, or even two or more components functioning together to change the operational mode of the input apparatus 100.

The memory 112 may comprise one or more volatile or non-volatile memory devices such as ROM, EEPROMs, etc. It may store code for performing any of the functions performed by the input apparatus. The code may be stored on any suitable computer readable media. Examples of computer readable media include magnetic, electronic, or optical disks, tapes, sticks, chips, etc. The code may also be written in any suitable computer programming language including Assembly, C, C++, etc.

The memory 112 may comprise code for allowing the input apparatus 100 to perform any of the functions described in this application. For example, the memory 112 may comprise code for activating the first sensor assembly 40 when the mode switch 34 is in the first mode and code for activating the second sensor assembly 66 when the mode switch 34 is in the second mode. It may also comprise code for allowing the ball 8 to perform 4-way 360 degree scrolling (i.e., scrolling in the vertical as well as the horizontal directions) in the second mode, and code for allowing the ball 8 to be used as a trackball in the first mode.

The host interface 118 may be an interface which allows the input apparatus to communicate with a host system such as computer system. Examples of host interfaces 118 include RF modules (which may include an antenna for receiving or sending signals to a corresponding antenna in a host system), input-output ports, etc.

Although separate functional blocks are shown in FIG. 8, it is understood that one functional block may be embodied by two or more actual physical components, or two or more functional blocks may be embodied by a single physical component. For example, the controller 108 and the memory 112 may be integrated into one package or chip. In another example, the memory 112 may be embodied by two or more memory chips or the like.

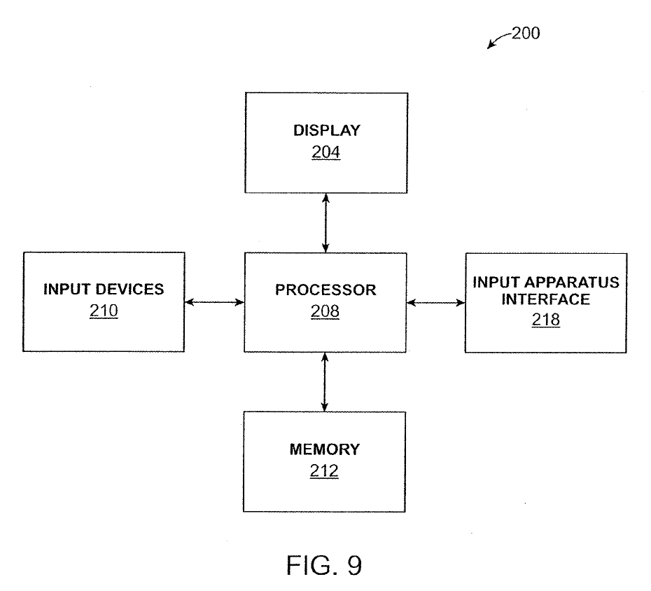

The input apparatus 100 may be used with a host system such as a host computer system (e.g., a personal computer, a television, etc.). Referring to FIG. 9, the host interface 118 may interface with an input apparatus interface 218 in a host system 200. The input apparatus interface 218 may be an interface which allows the host system 200 to communicate with the input apparatus 100. For example, the input apparatus interface 218 may comprise an antenna configured to receive RF signals from the host interface 118 of the input apparatus 100. It may be embodied by a separate device such as a dongle or a wireless device inside of a host system. In another example, the input apparatus interface 218 could be a port which is capable of interfacing with a wire that connects to the host interface 118.

As shown in FIG. 9, the host system 200 may comprise input devices (e.g., a keyboard) 210, a display 204, as well as a memory 212. A central processor 208 may be operatively coupled to the input devices 210, display 204, and memory 212. The host system may simply be a standard computer system such as a laptop computer system, a desktop computer system, or even a television. The memory 212 may comprise appropriate driver software to allow the input apparatus to work with the host system.

Referring to FIGS. 8 and 9, a method for using the above-described input apparatus 100 can include selecting the first mode using the mode switch 34 if the user wants to use the input apparatus 100 in a trackball mode. The ball 8 can be manipulated by the user to send a first control signal to the host system using the first sensor assembly 40, controller 108 and host interface 118. The control signal may control a cursor on a display 204 in the host system 200. The second optical sensor assembly 66 may be off when the mode switch 34 is in the first mode.

If the user wants to use the input apparatus 100 as mouse, then the user may select the second mode using the mode switch 34 to put the input apparatus 100 in a second mouse mode. Activation of the mode switch 34 switches the second optical sensor assembly 66 on and may optionally switch the first optical sensor assembly 40 off. Then, the user may move the input apparatus 100 to send a second control signal to the host system, using the second sensor assembly 66, the controller 108, and the host interface 118. The user may then move the input apparatus 100 over a work surface such as a desktop and may use it as a mouse. While in the second mode, the first optical sensor assembly 40 may remain on so that the user may use the ball 8 to scroll, by means of the 4-way 360 degree scrolling. This will send a third control signal using the first sensor assembly 40, controller 108 and host interface 118, to effect scrolling on a display 204 in the host system 200. In certain embodiments, the third control signal can be set by the user to perform other host system command, such as switching between computer applications.

The above-described input apparatus can be made using any suitable method. In one embodiment, the method comprises providing a housing comprising an upper portion and a lower portion, providing a ball at the upper portion of the housing, providing a first sensor assembly configured to sense the position of the ball, providing a second sensor assembly configured to sense the position of the input apparatus relative to a work surface, and providing a mode switch. The mode switch is operatively coupled to the first sensor assembly and the second sensor assembly. The mode switch comprises a first mode where the first sensor assembly is used to provide the control signal to the host system and a second mode where the second sensor assembly is used to provide the control signal to the host system. In particular, the components shown in FIG. 5 can be assembled together in any suitable order to create the input apparatus.

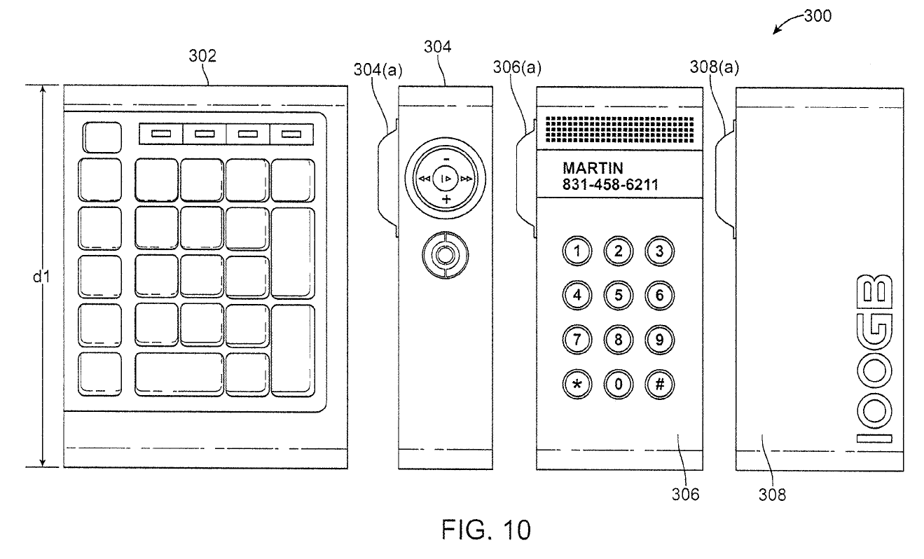

The input apparatus 100 can be used in a workstation with a modular desktop assembly 300 like the one shown in FIG. 10. The assembly 300 comprises a keyboard 302, as well as a plurality of control devices 304, 306, and a memory device 308. In this example, the control devices 304, 306 comprise a presentation control device 304 and a phone 306. However, any other types of devices could be used in the modular desktop assembly 300.

Male connectors 304(a), 306(a), 308(a) may be associated with the control devices 304, 306, and the memory device 308, so that they can be releasably connected to each other in any way that the user desires. The connectors 304(a), 306(a), 308(a) and the corresponding female connectors (not shown) may be purely mechanical connectors, or may be electromechanical connectors, allowing the devices 304, 306, 308 to receive power or control signals through the keyboard 302.

As shown, the keyboard 302 may have a length d1 and the other control devices 304, 306, 308 may have similar lengths, and similar heights, but varying widths.

When connected together, the desktop assembly appears as if it is one integral unit even though the parts can be separated from each other. In embodiments of the invention, a keyboard, a first control device, and a second control device can all have at least two dimensions (e.g., length and thickness) that are substantially the same.

It is noted that the present invention is not limited to the preferred embodiments described above, and it is apparent that variations and modifications by those skilled in the art can be performed within the spirit and scope of the present invention. Moreover, any one or more embodiment of the invention may be combined with one or more embodiments of the invention without departing from the spirit and scope of the invention.

Any recitation of “a”, “an” and “the” is interpreted to mean “one or more” unless specifically indicated to the contrary.

All U.S. provisional and non-provisional patent applications and publications mentioned above are incorporated by reference in their entirety for all purposes. None is admitted to be prior art.

What is claimed is:

1. An input apparatus for providing a control signal to a host system, the input apparatus comprising:
a housing comprising an upper portion and a lower portion;
a ball at the upper portion of the housing;
a first sensor assembly configured to sense the position of the ball;
a second sensor assembly configured to sense the position of the input apparatus relative to a work surface; and
a mode switch, wherein the mode switch is operatively coupled to the first sensor assembly and the second sensor assembly, the mode switch comprising a first mode where the first sensor assembly is used to provide the control signal to the host system and a second mode where the second sensor assembly is used to provide the control signal to the host system.

2. The input apparatus of claim I wherein the first sensor assembly is a first optical sensor assembly and the second sensor assembly is a second optical sensor assembly.

3. The input apparatus of claim 1 wherein the ball has a diameter less than about 10 mm.

4. The input apparatus of claim 1 further comprising a controller operatively coupled to the mode switch, the first sensor assembly, and the second sensor assembly.

5. The input apparatus of claim 1 further wherein the mode switch comprises button, wherein the button is in the form of a bezel, and wherein the ball is within the bezel.

6. The input apparatus of claim 1 further comprising first and second buttons, wherein the first and second buttons are on opposite sides of the ball.

7. The input apparatus claim 1 wherein the first sensor assembly is a first optical sensor assembly and the second sensor assembly is a second optical sensor assembly, and wherein the first and second optical sensor assemblies comprise lasers.

8. The input apparatus of claim 1 further comprising a controller operatively coupled to the mode switch, the first optical sensor assembly, and the second optical sensor assembly, and wherein the input apparatus further comprises a host interface.

9. The input apparatus of claim 8 wherein the host interface is a wireless interface.

10. The input apparatus of claim 1 further comprising a controller operatively coupled to the mode switch, the first sensor assembly, and the second sensor assembly, and wherein the input apparatus further comprises a host interface and a memory operatively coupled to the controller, wherein the memory comprises code for activating the first sensor assembly when the mode switch is in the first mode and code for activating the second sensor assembly when the mode switch is in the second mode.

11. The input apparatus of claim 1 wherein the control signal is used to control a cursor displayed on the host device.

12. The input apparatus of claim 1 wherein the control signal is a first control signal, and the first sensor assembly is used to provide a second control signal while the input apparatus is in the second mode.

13. A method for using the input apparatus of claim 1, the method comprising:
selecting the first mode using the mode switch;
using the ball to send a first control signal to the host system;
selecting the second mode using the mode switch; and
moving the input apparatus to send a second control signal to the host system.

14. The method of claim 13 further comprising:
using the ball to scroll when the input apparatus is in the second mode.

15. The method of claim 13 wherein the ball has a diameter less than about 10 mm.

16. The method of claim 13 wherein mode switch is in the form of a button.

17. A modular desktop assembly comprising:
a keyboard comprising a first connector; and
a control device comprising a second connector, wherein the first connector is connectable to the second connector.

18. The modular desktop assembly of claim 17 wherein the control device is a first control device and wherein the first control device comprises a third connector, and wherein the modular desktop assembly comprises a second control device comprising a fourth connector connectable to the third connector.

19. The modular desktop assembly of claim 18 wherein the first control device is a numeric keypad and the second control device is a television controller.

20. The modular desktop assembly of claim 19 wherein the first control device and the second control device are flat.

21. The modular desktop assembly of claim 20 wherein the keyboard, the first control device, and the second control device all have at least two dimensions that are substantially the same.

22. A ball assembly for providing a control signal, the ball assembly comprising:
a housing;
a holding structure;
a ball cooperatively configured with the holding structure, wherein the ball is accessible from outside the housing; and
a sensor assembly configured to sense the relative movement of the ball.

23. The ball assembly of claim 22, wherein the sensor assembly is an optical sensor assembly.

24. The ball assembly of claim 23, wherein the sensor assembly includes a laser.

25. The ball assembly of claim 22, wherein the holding structure comprises a ring shaped structure.

26. The ball assembly of claim 22, wherein the ball has a diameter and the holding structure has an inside diameter, and further wherein the inside diameter is smaller than the diameter of the ball.

27. The ball assembly of claim 22, wherein the ball is disposed within a cavity at a first side of the holding structure, and the sensor assembly is mounted on a second side of the holding structure.

28. The ball assembly of claim 27, wherein the cavity is defined by walls that slope inward such that the ball is held between the cavity and the housing.

29. The ball assembly of claim 27, wherein the ball has a curvature, and further wherein the cavity has walls that conform to the curvature of the ball.

30. The ball assembly of claim 22, wherein the housing includes an opening such that the ball is accessible through the opening.

31. The ball assembly of claim 22, wherein the holding structure comprises a low-friction material.

32. The ball assembly of claim 31, wherein the holding structure comprises a fluoropolymer.

33. The ball assembly of claim 28, further comprising:
a biasing member between the holding structure and the ball, wherein the biasing member is configured to provide force against the ball in the direction of the housing.

34. The ball assembly of claim 22, wherein the ball has a diameter within the range of approximately 7-15 mm.
